(19) United States
(12) Patent Application Publication
(10) Pub. No.: US 2001/0044844 A1
(43) Pub. Date: Nov. 22, 2001

(54) Method and system for analyzing performance of large-scale network supervisory system

(76) Inventor: Masahiro Takei, Tokyo (JP)

Correspondence Address: McGinn & Gibb, PLLC, Suite 200, 8321 Old Courthouse Road, Vienna, VA, 22182-3817, US

(21) Appl. No.: 09/854,517

(22) Filed: May 15, 2001

(30) Foreign Application Priority Data
May 17, 2000 (JP) 144640/2000

(51) Int. Cl. G06F 15/173

(52) U.S. Cl. 709/224

(57) ABSTRACT

To provide a method for analyzing performance of a large-scale network supervisory system that can provide evaluation results of a network supervisory system promptly. An input device allows network configuration information to be stored as a sub-model in a storage section, device performance information, and a data traffic patterns to be stored in a parameter storage section. A performance evaluation controller acquires the data traffic patterns from the parameter storage section, and acquires a sub-model to be analyzed from the model storage section. The performance evaluation controller calculates a performance value in an approximate calculation section, if the performance analysis of the sub-model is to be subjected to approximate calculation, or analyzes the performance value employing a queue analytical section if it is not be subjected to approximate calculation, and outputs performance analytical results to an evaluation result output device.

### BACKGROUND OF THE INVENTION

The present invention relates to a method and system for analyzing performance of a large-scale network supervisory system in a performance analytical system for a supervisory network and supervisory equipment in a supervisory system where there are a large number of supervisory object devices involves, in which approximate calculation is used for a portion that takes a lot of time to perform simulation, while a queuing simulation is employing for other portions to output evaluation results in a short time.

### DESCRIPTION OF RELATED ART

A system for analyzing the performance of a supervisory system is described in Japanese Patent Laid-Open No. 11-331162 (hereinafter referred to as a first gazette). The system described in the first gazette employs a finite state machine method for executing the performance evaluation, where a means for preparing a model performs modeling of an internal of transmission equipment by which an administrative network is conformed, by using a finite state machine method. Furthermore, a device model is used for modeling the administrative network. In that modeling, the inside of the equipment is defined to be handled as a sub-network in the whole of the administrative network.

A means for computing a network performance then analyzes the performance of the administrative network according to prepared model data and parameters given previously, by using a finite state machine method. An evaluation means evaluates the performance of the network, by changing parameters associated with the inside of the transmission equipment and/or topology of the administrative network, if necessary, for the performance analytical result of the means for computing a network performance.

Japanese Patent Laid-Open No. 10-290227 (hereinafter referred to as a second gazette) discloses an analytical system of OSI network administrative protocol performance, which is capable of analyzing the performance of complicated and large scale system on a basis of a queuing theory.

In the second gazette, a model conversion for reducing the number of chains is conducted, where a modeling conversion section substitutes an OSI network administrative protocol modeled by a modeling section with one closed chain and one open chain. With this conversion, a performance analytical section in the next stage applies “a calculation method for mixed queuing network”. Therefore, computation capable of saving the time and the amount of memory required by a computer can be executed.

A section of calculating average number of visitors calculates from a result of the performance analytical section, that is, a performance analytical result after the modeling conversion has been performed, average number of visitors at each service center. A transversal time calculation section calculates a transversal time of each protocol which corresponds to a modeling before the conversion is performed.

However, analysis using a finite state machine method as described in the first gazette has a problem that simulation for analyzing a large-scale network takes too much time. Accordingly, performance evaluation for various models, and prompt comparison and investigation between models using this method are impossible.

In a system as described in the second gazette, a performance evaluation operation fails to adopt a method in which an approximate calculation is used for a portion which takes time for simulation, while queuing simulation is used for other portions. Similar to the system of the first gazette, the second gazette system has a problem that evaluation result cannot be obtained with rapidity.

The present invention has been achieved to solve the aforementioned problems. An object of the present invention is to provide a method and system for analyzing the performance of a large-scale network supervisory system in which evaluation results can be obtained promptly, by making performance evaluation using the queuing analysis and the approximate calculation on a case-by-case basis.

### SUMMARY OF THE INVENTION

To accomplish the above object, according to the present invention, there is provided a method for analyzing performance of a large-scale network supervisory system, where configuration of a supervisory-system network which is a performance analytical object has a supervisory equipment, and a plurality of supervisory object devices connected to and supervised by said supervisory equipment, said method comprising the steps of: enabling a user to input to an input device network configuration information on said supervisory-system network, device performance information regarding said supervisory equipment and said supervisory object devices, and data traffic patterns associated with said supervisory equipment and said supervisory object devices; storing in a model storage section via said input device said network configuration information in which a function of said network configuration is combined as a sub-model, and said device performance information; storing in a parameter storage section by means of said input device said device performance information and said data traffic patterns; activating a performance evaluation section by said input device to acquire information regarding said data traffic patterns from said parameter storage section; preparing a generation schedule of packets generated by said supervisory equipment and said supervisory object devices; analyzing performance of each of said packets correspondingly associated with said supervisory equipment or said supervisory object devices; and calculating approximate calculation value in a case where said sub-model to be analyzed, which has been acquired from said model storage section, is a sub-model to be subjected to approximate calculation, calculating performance value in a case where said sub-model is a sub-model on which no approximate calculation is performed, and outputting to an evaluation result output device performance analytical results by combining said approximate calculation value and said performance value.

The present invention further comprises the steps executed in said performance evaluation section, said steps including; performing in a queuing analytical section queuing simulation by inputting connection information on the queuing, and performance information regarding packet arrival intervals and a service rate; outputting from a queuing analytical section a packet processing time, and a utilization factor and a queue length of each queue; holding in an approximate calculation section a functional algorithm and a conversion table used for performing approximation on performance value including a delay time of a model, and outputting an approximate value of the performance value to be obtained for the input; and calculating in a performance evaluation controller in accordance with information from said approximate calculation section, said model storage section, and said parameter storage section, by utilizing said approximate calculation section for portion of a model to be simulated by the approximate calculation, and by using said queuing analytical section for other portions, performance analytical results by combining analytical values from associated two kinds of modules.

The evaluation result output device according to the present invention displays the amount of money required for a system construction, by inputting said performance analytical results obtained in said performance evaluation section, and a price of a supervisory system to be evaluated that has been calculated by a device cost calculation section from said network configuration information stored in said model storage section and price information associated with each component of the network configuration.

The present invention also provides a system for analyzing performance of a large-scale network supervisory system comprising: an input device for enabling a user to input network configuration information on a supervisory-system network, device performance information regarding a supervisory equipment and supervisory object devices, and data traffic patterns associated with said supervisory equipment and said supervisory object devices; a model storage section for storing via said input device said network configuration information in which a function of said network configuration is combined as a sub-model, and said device performance information; a parameter storage section for storing said device performance information, and said data traffic patterns by means of said input device; and a performance evaluation section for acquiring information on said data traffic patterns from said parameter storage section activated by said input device, for preparing a generation schedule of packets generated by said supervisory equipment and said supervisory object devices, for analyzing performance of each packet correspondingly associated with said supervisory equipment or said supervisory object devices, and for calculating approximate calculation value in a case where said sub-model to be analyzed, which has been acquired from said model storage section, is a sub-model to be subjected to approximate calculation, calculating performance value in a case where said sub-model is a sub-model on which no approximate calculation is performed, and outputting to an evaluation result output device performance analytical results by combining said approximate calculation value and said performance value.

The performance evaluation section according to a system for analyzing performance of a large-scale network supervisory system comprises a queuing analytical section for performing queuing simulation by inputting connection information on the queuing, and performance information regarding packet arrival intervals and a service rate; a queuing analytical section for outputting a packet processing time, and a utilization factor and a queue length of each queue; an approximate calculation section for holding a functional algorithm and a conversion table used for performing approximation on performance value including a delay time of a model, and outputting an approximate value of the performance value to be obtained for the input; and a performance evaluation controller for calculating, in accordance with information from said approximate calculation section, said model storage section, and said parameter storage section, by utilizing said approximate calculation section for portion of a model to be simulated by the approximate calculation, and by using said queuing analytical section for other portions, performance analytical results by combining analytical values from associated two kinds of modules.

### BRIEF DESCRIPTION OF THE DRAWINGS

The objects and features of the present invention will become more apparent from the consideration of the following detailed description taken in conjunction with the accompanying drawings, in which:

FIG. 1 is a block diagram showing configuration of a system for analyzing the performance of a large-scale network supervisory system according to a first embodiment of the present invention;

FIG. 2 is a diagram showing configuration of a supervisory network applied to a method and system for analyzing the performance of a large-scale network supervisory system according to the first embodiment;

FIG. 3 is a table which contains lists of performance information regarding a supervisory equipment, a supervisory object device, and a hub applied to a method and system for analyzing the performance of a large-scale network supervisory system according to the present invention;

FIG. 4 shows data traffic patterns assumed when evaluating the performance of a supervisory system by a method and system for analyzing the performance of a large-scale network supervisory system according to the present invention;

FIG. 5 is a flowchart showing operation associated with a method and system for analyzing the performance of a large-scale network supervisory system according to the present invention;

FIG. 6 is a flowchart showing a processing procedure for analyzing a single packet as described in step A4 of FIG. 5;

FIG. 7 is a block diagram showing configuration of a system for analyzing the performance of a large-scale network supervisory system according to a second embodiment of the present invention;

FIG. 8 is a block diagram showing configuration of a system for analyzing the performance of a large-scale network supervisory system according to a third embodiment of the present invention;

FIG. 9 is a diagram illustrating configuration of a supervisory network which employs a high-speed hub applied to a method and system for analyzing the performance of a large-scale network supervisory system according to the third embodiment; and

FIG. 10 is a diagram illustrating configuration of a supervisory network which employs a high-speed supervisory equipment applied to a method and system for analyzing the performance of a large-scale network supervisory system according to the third embodiment.

### DESCRIPTION OF THE PREFERRED EMBODIMENTS

Referring now to the drawings, the preferred embodiments of the invented method and system for analyzing the performance of a large scale network supervisory system will be described.

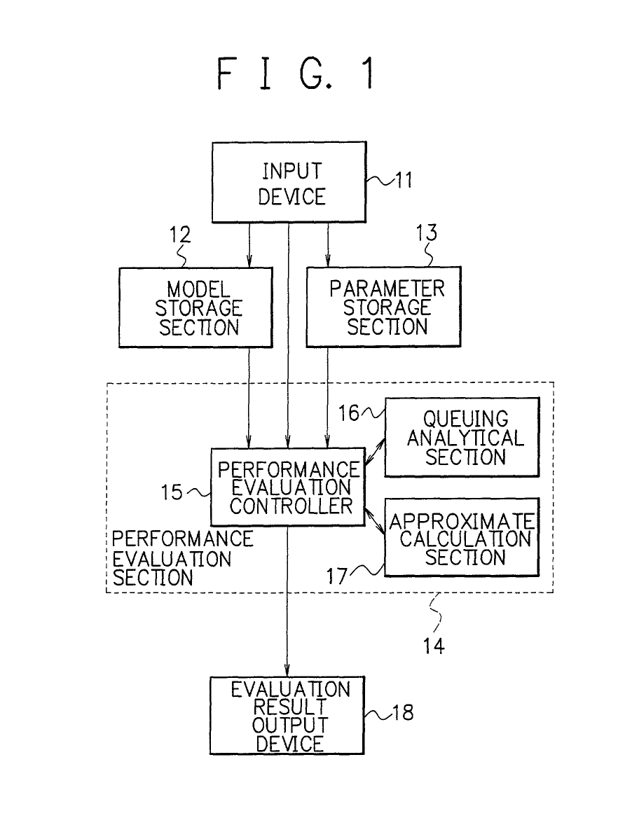

FIG. 1 is a block diagram showing the configuration of a performance analytical system of a large-scale network supervisory system according to a first embodiment of the present invention. In FIG. 1, a supervisory system is represented as a model having a combination of functions, say the functions of the Ethernet, a hub, and a buffer (sub-models). A user inputs parameters of each sub-model such as a communication rate and the capacity of buffer into an input device 11, together with information regarding data traffic patterns or the like that are exchanged in the supervisory system.

A performance analytical section 14 is composed of a performance evaluation controller 15, a queuing analytical section 16, and an approximate calculation section 17. The performance evaluation controller 15 performs a performance evaluation in accordance with information from a model storage section 12 and a parameter storage section 13, in which features of the supervisory system inputted by the user are stored. The performance evaluation controller 15 stores in advance information on a sub-model configuration to which an approximate calculation is performed. For analyzing performance of the sub-model, the controller 15 uses the approximate calculation section 17 to calculate the performance value. For other sub-models, the queuing analytical section 16 is used to calculate the performance value in a simulation manner. The performance evaluation controller 15 calculates the performance value of the whole model by mixing performance values obtained from the queuing analytical section 16 and the approximate calculation section 17, thus sending the performance value to an evaluation result output device 18.

In a queuing simulation, any network configuration can be modeled to evaluate the performance, however the simulation takes some time. A large-scale configuration having several hundreds devices to be simulated may take several days for the evaluation.

On the other hand, some sub-models allow for solution using the approximate value. A calculation using the approximate value can be executed only by looking up a table, performing calculation of an approximation equation, and the like, therefore the calculation time becomes short.

It is a characterizing feature of the present invention that the invention provides a performance analytical method and a system thereof capable of analyzing sub-models within a given model in an appropriate manner and allowing a rapid evaluation. Details of the first embodiment will be described below.

The input device 11 is used to input the features of the supervisory system to be evaluated. The model storage section 12 stores information regarding internal configuration of a supervisory object device and/or a supervisory equipment, and a supervisory-system network configuration. The parameter storage section 13 stores performance values such as a processing speed of the supervisory object device and supervisory equipment, and a rate of communication buffers and a network. It also stores setup values regarding a traffic such as the frequency of administration message, and the amount of data exchanged between respective devices.

The performance evaluation section 14 is activated by the input device 11 to execute performance evaluation in accordance with the model inputted from the model storage section 12 and to the parameters inputted from the parameter storage section 13. The evaluation results are sent to the evaluation result output device 18.

It is noted that this model has as sub-models, the functions of a network configuration such as the Ethernet, a hub, and a buffer. A combination of these sub-models is network configuration information for this model.

The queuing analytical section 16 performs a queuing simulation by inputting connection information such as queuing, and performance information such as a packet arrival interval, and a service rate. The section 16 then outputs a processing time of packets, a utilization factor and queue length of each queue, and the like. The approximate calculation section 17 internally holds a functional algorithm and a conversion table for previously approximating performance values (e.g., a delay time) of a model, and outputs approximation of the performance value to be obtained for the input.

As mentioned above, the performance evaluation controller 15 utilizes the approximate calculation section 17 for portion of the model to be simulated by the approximate calculation, in accordance with information from the approximate calculation section 17, the model storage section 12, and the parameter storage section 13. Other than that portion, the controller 15 uses the queuing analytical section 16. Performance analytical results obtained by combining analytical values from these two kinds of modules are sent to the evaluation result output device 18.

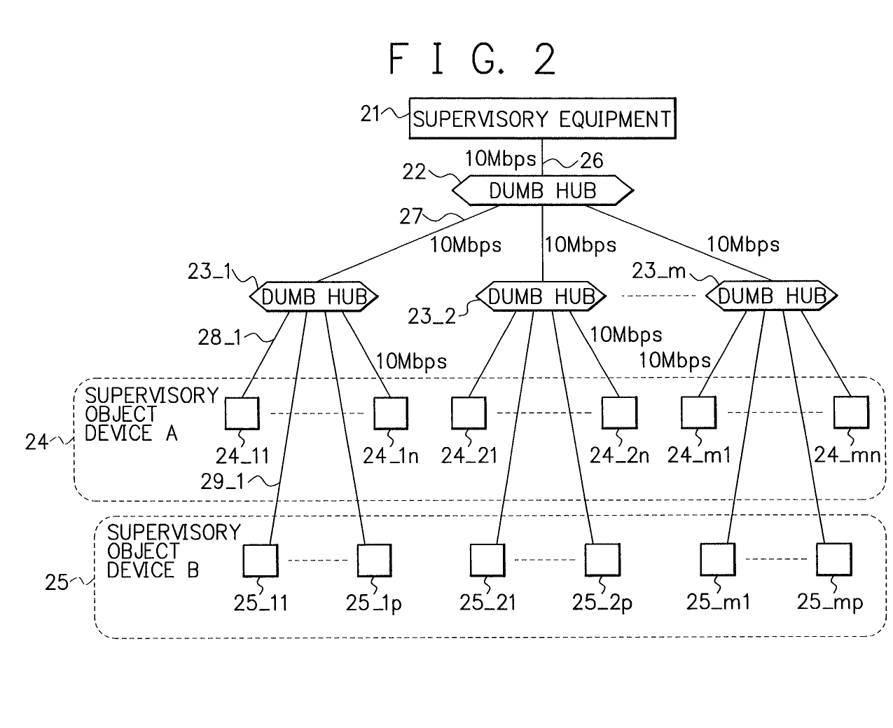

Referring now to FIG. 2, a supervisory-system network configuration which is a performance analytical object and applied to the present invention, will be described below. As shown in FIG. 2, a supervisory equipment 21 includes plural kinds of supervisory object devices A with a numeral reference 24 and B referenced by 25. The supervisory object device A (24) comprises a number of supervisory object devices 24_11 to 24_1n, 24_21 to 24_2n, and 24_m1 to 24_mn.

Similarly, the supervisory object device B (25) comprises a number of supervisory object devices 25_11 to 25_1p, 25_21 to 25_2p, and 25_m1 to 25_mp. The actual communication system may have 200 or more supervisory object devices, provided that a wavelength division multiplexing (WDM) is employed.

The supervisory object devices 24_11 to 24_1n as the supervisory object device A (24) are respectively connected to a dumb hub 231 through a communication path 28_1 at a rate of 10 Mbps, and the supervisory object devices 25_11 to 25_1p which make up the supervisory object device B (25) are also connected to the dumb hub 23_1 through a communication path 29_1 at a rate of 10 Mbps.

Likewise, the supervisory object devices 24_21 to 24_2n of the supervisory object device A are connected to a dumb hub 23_2 at a rate of 10 Mbps, and the supervisory object devices 24_m1 to 24_mn of the supervisory object device A are connected to a dumb hub 23_m at a rate of 10 Mbps. The supervisory object devices 25_21 to 25_2p of the supervisory object device B are connected to the dumb hub 23_2 at a rate of 10 Mbps, and the supervisory object devices 25_m1 to 25_mp to the dumb hub 23_m at the same rate of 10 Mbps.

The dumb hubs 23_1 to 23_m are respectively connected to a dumb hub 22 at a rate of 10 Mbps. The dumb hub 22 is connected to the supervisory equipment 21 at a rate of 10 Mbps via a communication path 26.

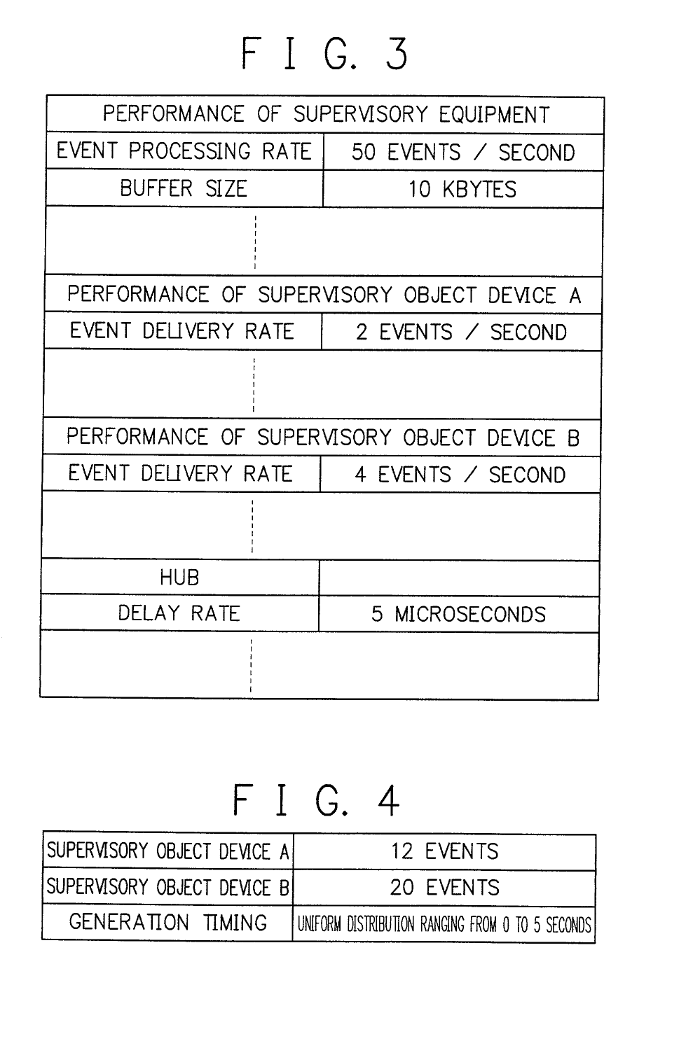

FIG. 3 is an explanatory table listing performance information with regard to the supervisory equipment 21, and the supervisory object devices A (24) and B (25). As shown in FIG. 3, listed items for the supervisory equipment 21 include an event processing rate (50 events/second) indicating the performance value for processing notification or information from the supervisory object devices A and B, the size of a buffer (10 Kbytes) for storing notifications which are waiting to be processed. As for the supervisory object device A, listed items include the performance value related to an event delivery rate (2 events/second) that is an event notifying performance per second. Listed items for the supervisory object device B include an event delivery rate (4 events/second) indicative of an event notifying performance per second. For the hub, there is listed the performance value such as a delay rate (5 microseconds).

FIG. 4 shows data traffic patterns related to assumption employed in this performance evaluation. More specifically, it is assumed in the performance analysis that a large amount of notifications are delivered in a short time from the supervisory object devices A and B to the supervisory equipment 21. That is, after occurrence of a certain event, the supervisory object devices A (24) and B (25) respectively deliver a predetermined notification to the supervisory equipment 21 with the maximum event-notification performance possessed by each of these supervisory object devices, at elapse of a certain delay time.

FIG. 4 shows the number of packets sent at a time from the supervisory object devices A and B, and a delay time at which notifications are started to occur from each of the supervisory object devices, by which the data traffic is characterized.

Description is now given of the operation of the system for analyzing the performance of a large-scale network supervisory system according to the first embodiment of the present invention. A method of analyzing the performance of a large-scale network supervisory system according to the present invention will be apparent from the operation described below.

In the first place, a user inputs network configuration information, device performance information, and the data traffic patterns by using the input device 11. The model storage section 12 stores the network configuration information sent from the input device 11, and the parameter storage section 13 stores the device performance information and the data traffic patterns which have also been sent from the input device 11. After that, the input device 11 activates the performance evaluation controller 15.

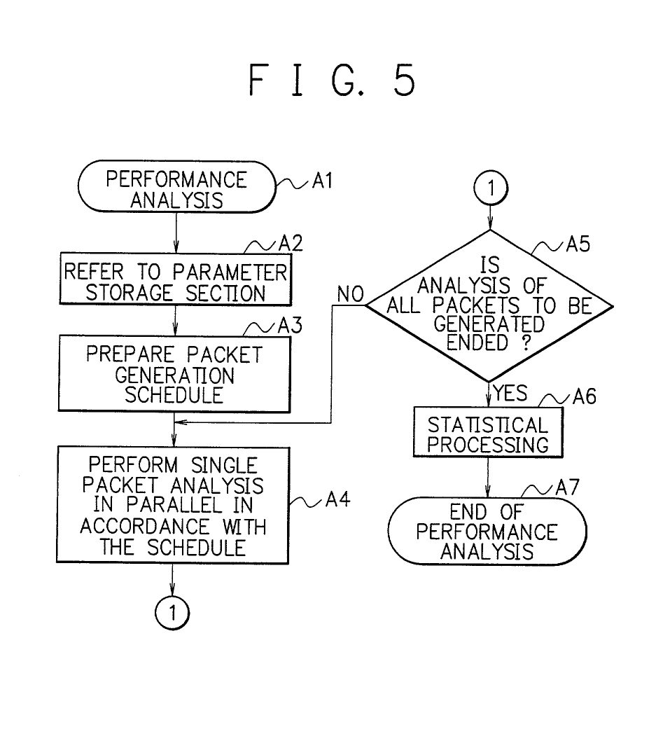

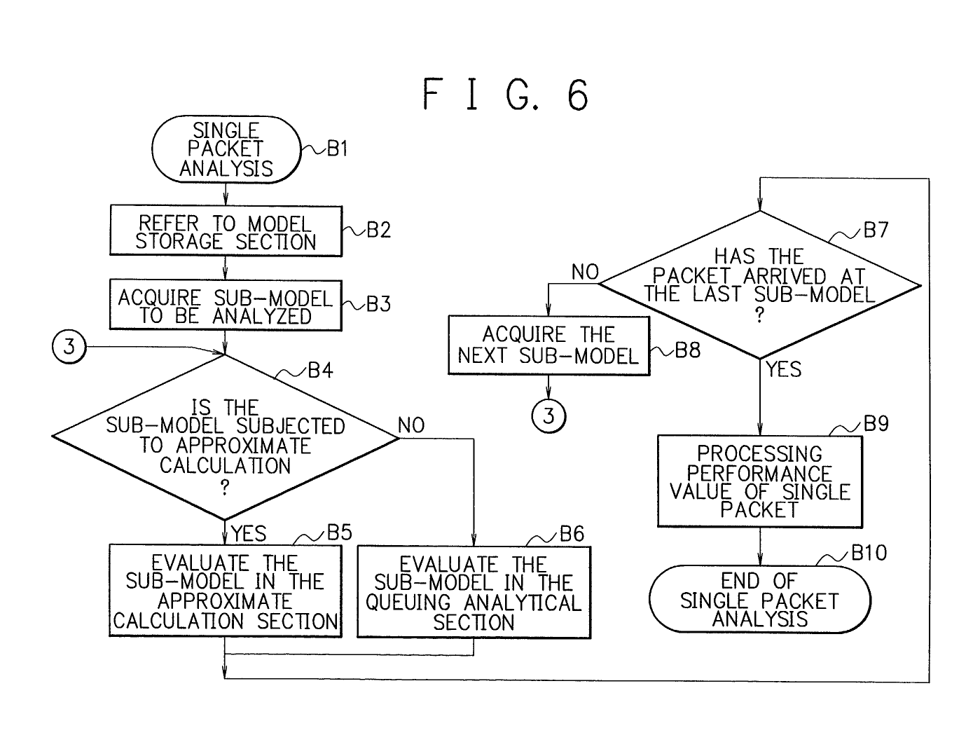

FIGS. 5 and 6 are a flowchart illustrating operation of the performance evaluation controller 15. The operation of the controller 15 will be described below with reference to FIGS. 5 and 6. As shown in FIG. 5, when a performance analysis is started in step A1, the performance evaluation controller 15 acquires information regarding data traffic patterns from the parameter storage section 13 (step A2). The controller 15 then prepares a generation schedule of packets to be generated in the supervisory equipment 21, and each of the supervisory object devices A and B (step A3).

It should be noted that the time with respect to the generation schedule is not a real time, but a virtual time managed within the performance evaluation controller 15 for simulation.

If it is the time determined in the generation schedule, the analytical simulation of packets generated from the corresponding device is started (step A4). This is a single packet analysis performed in a parallel manner. If all the packets generated by a scheduler are processed in step A5, a statistical processing is performed to take a mean value, a maximum value, a minimum value, and a standard deviation of the results obtained by processing each packet (step A6). The performance analysis is thus ended in step A7.

FIG. 6 shows a procedure for analyzing a single packet as described in step A4 of FIG. 5. As shown in FIG. 6, when the single packet analysis is started in step B1, the performance evaluation controller 15 refers in step B2 to the model storage section 12. The controller 15 then acquires a sub-model to be analyzed in step B3.

In a case of the data traffic patterns assumed in the present embodiment, the sub-model acquired is a supervisory object device.

In step B4, the performance evaluation controller 15 determines whether or not a performance value analysis of the sub-model is to be performed on the basis of the approximate value. If it is a sub-model to be subjected to the approximate calculation, the performance value is calculated using the approximate calculation section 17 (step B5).

If it is a sub-model to which the approximate calculation should not be applied, the performance value is analyzed using the queuing analytical section 16 (step B6).

The performance evaluation controller 15 decides in step B7 whether or not a packet arrives at the last sub-model. If it is not, the controller 15 refers to the model storage section 12 to acquire a sub-model to which a packet is to be destined, thus analyzing the sub-model (step B8).

If a packet arrives at the last sub-model, the performance value such as the in-model transversal time with respect to the packet is calculated in step B9. The analysis of a single packet is thus ended in step B10. Specifically, the performance-degradation calculation for bus arbitration executed in the Ethernet can be exemplified as the approximate calculation. The Ethernet employs CSMA/CD (Carrier Sense Multiple Access/Collision Detection) as a bus arbitration method performed when the data is sent simultaneously from a plurality of devices.

In a case where this method is represented in terms of queuing, it is required a complicated processing such as detection of request for a simultaneous transmission or calculation of a retransmission timing when the simultaneous transmission is requested in the Ethernet. It therefore takes a lot of time for this method to process a large number of packets.

On the other hand, it is well known that CSMA/CD has statistically a performance degradation in a transmission path when a simultaneous transmission is required. Therefore, a delay in the Ethernet is obtained by the approximate calculation based on the number of packets that are simultaneously propagating on the Ethernet.

When the analysis for all the packets is completed in the performance evaluation controller 15, performance analytical results such as a packet delay time and bottle neck associated with the analytical object model are displayed by the evaluation result output device 18.

According to the first embodiment of the present invention, a time-consuming processing is performed in the approximate calculation section, and furthermore a queuing analysis and approximate calculation are selectively carried out with respect to the performance evaluation. Therefore, the evaluation results can be obtained with rapidity.

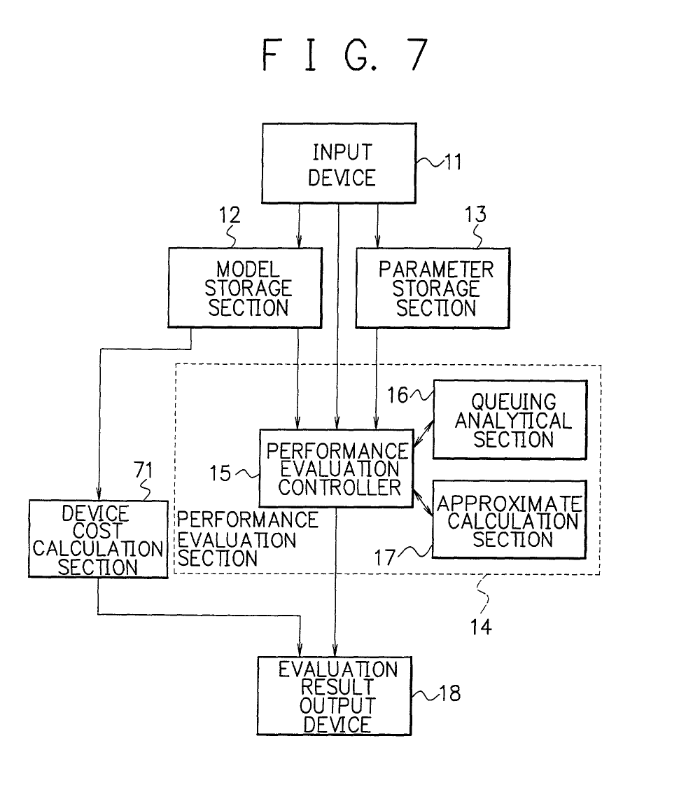

Description will be given of a method and system for analyzing the performance of a large-scale network supervisory system according to a second embodiment of the present invention. FIG. 7 is a block diagram showing the configuration of a performance analytical system of a large-scale network supervisory system according to the second embodiment.

As apparent from FIG. 7, the performance analytical system of a large-scale network supervisory system according to the second embodiment has a device cost calculation section 71, in addition to the configuration associated with the first embodiment as shown in FIG. 1. The device cost calculation section 71 is used to calculate a price of the supervisory system to be evaluated, in accordance with network configuration information (connection information) and price information regarding each component.

In a method and system for analyzing the performance of a large-scale network supervisory system according to the second embodiment of the present invention, to which the device cost calculation section 71 is appended, the section 71 holds configuration information regarding various kinds of network devices such as a variety of computers, hubs, and routers which constitute a supervisory network, and price information on these components. The section 71 then calculates the amount of money necessary for construction of the supervisory system, in accordance with the number of devices and its performance used in the evaluation object model that are stored in the model storage section 12.

The evaluation result output device 18 displays the amount of money necessary for constructing the system which has been obtained in the device cost calculation section 71, together with performance analytical results associated with a model which have been obtained in the performance evaluation section 14 and the performance evaluation controller 15.

In addition to advantage obtained in the system according to the first embodiment, the second embodiment system displays the amount of money necessary for constructing the supervisory system, whereby it is possible for the user to easily select a model with an excellent cost performance.

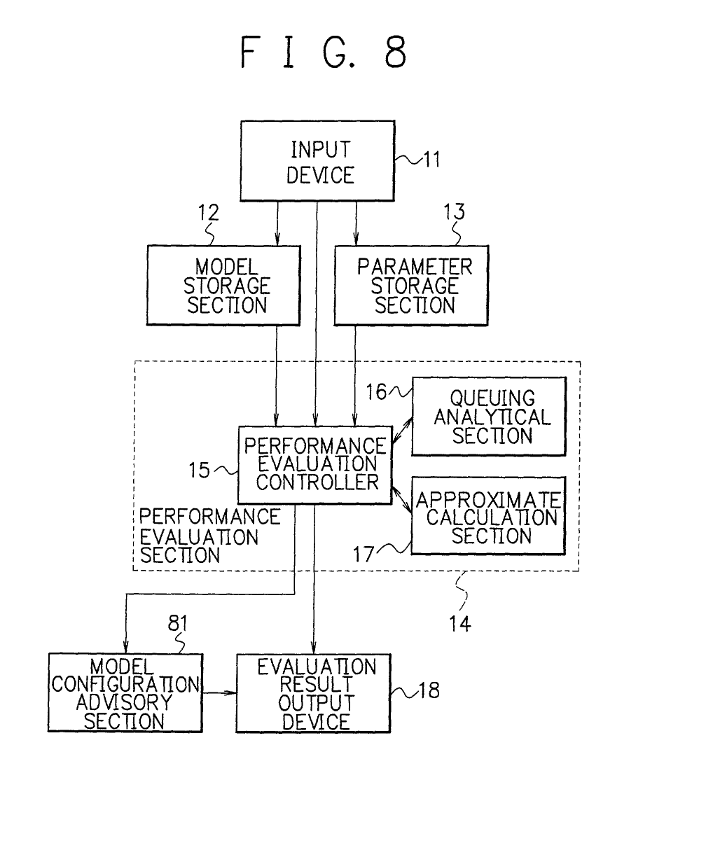

With reference now to FIGS. 8 to 10, a method and system for analyzing the performance of a large-scale network supervisory system according to a third embodiment of the present invention will be described in detail below.

FIG. 8 is a block diagram showing the configuration of a performance analytical system of a large-scale network supervisory system according to the third embodiment. Compared with first embodiment configuration, the performance analytical system according to the third embodiment as shown in FIG. 8 additionally has a model configuration advisory section 81 for giving a user advice as to portion which requires improvements, in accordance with performance analytical results.

The model configuration advisory section 81 so provided in the performance analytical system of a large-scale network supervisory system according to the third embodiment, checks whether or not a model is valid based on analytical results obtained by the performance evaluation controller 15. If there is any sub-model in which a bottle neck exists, the advisory section 81 outputs a location where the bottle neck exists and suggestions for improvements.

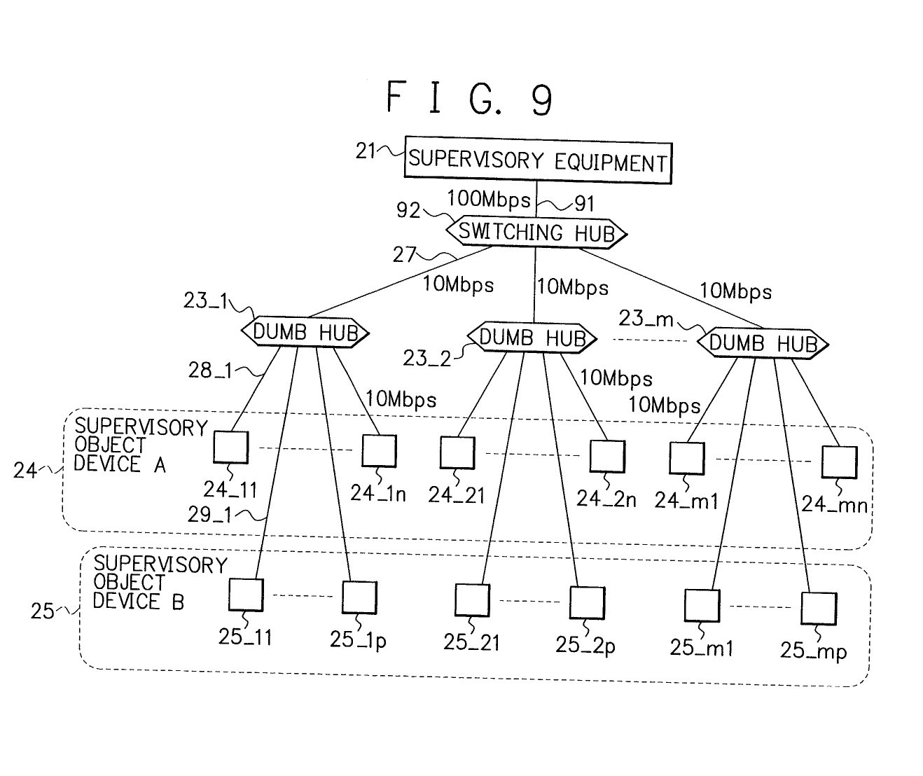

For example, if the communication path 26 with a rate of 10 Mbps located between the supervisory equipment 21 and the dumb hub 22 is a bottle neck in the model as shown in FIG. 2, the dumb hub 22 is replaced with a switching hub 92, and the path 26 is changed to a communication path 91 with a rate of 100 Mbps as shown in FIG. 9, so that the rate of the communication path is increased.

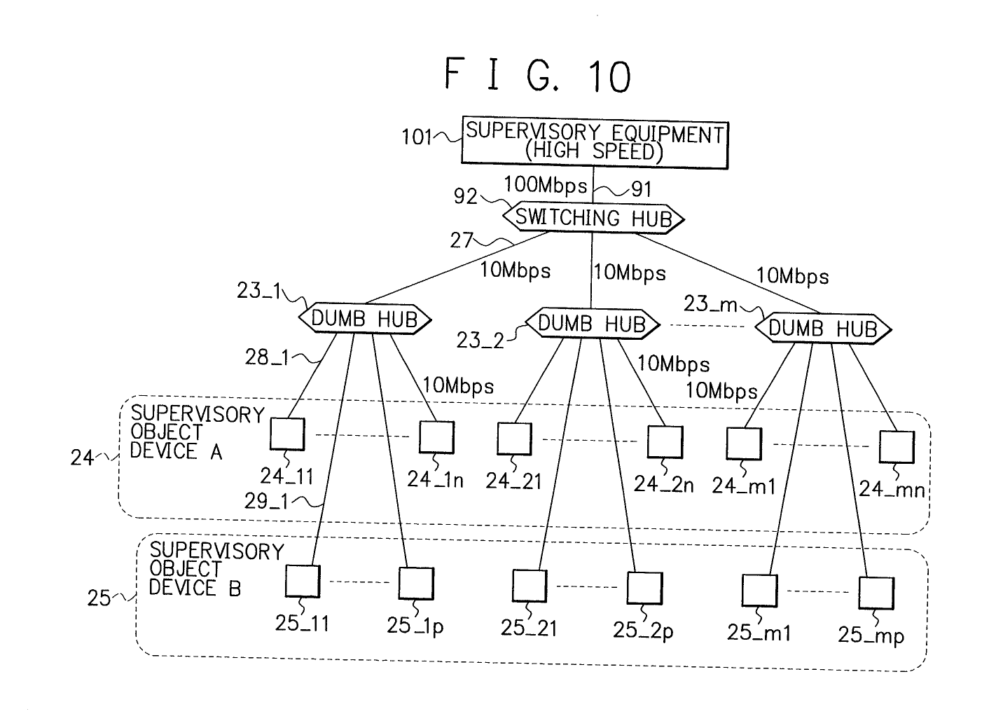

In a case where an internal processing associated with the supervisory equipment 21 is a bottle neck as well as those described above, the supervisory equipment 21 in a supervisory-system network configuration as shown in FIG. 2 or 9 is changed to a supervisory equipment 101 as shown in FIG. 10, which has a higher processing speed.

With this configuration, the evaluation result output device 18 displays portion where a bottle neck exists and suggestions for improvements in accordance with an output from the model configuration advisory section 81 if there is any output, together with performance analytical results of a model obtained in the performance evaluation controller 15.

According to the third embodiment of the present invention, since the performance evaluation system outputs suggestions for improvements, in addition to advantage obtained in the system according to the first embodiment, a user can easily evaluate various kinds of models.

As described above, according to the method and system for analyzing the performance of a large-scale network supervisory system of the present invention, a queuing analysis and approximate calculation are selectively carried out with respect to the performance evaluation. That is, the performance evaluation controller utilizes the approximate calculation section for portion of the model to be simulated by the approximate calculation, in accordance with information from the approximate calculation section, the model storage section, and the parameter storage section. For other portions, the controller uses the queuing analytical section. Performance analytical results obtained by combining analytical values from these two kinds of modules are sent to the evaluation result output device, whereby the evaluation results can be obtained promptly.

What is claimed is:

1. A method for analyzing performance of a large-scale network supervisory system, where configuration of a supervisory-system network which is a performance analytical object has a supervisory equipment, and a plurality of supervisory object devices connected to and supervised by said supervisory equipment, said method comprising the steps of:
enabling a user to input to an input device network configuration information on said supervisory-system network, device performance information regarding said supervisory equipment and said supervisory object devices, and data traffic patterns associated with said supervisory equipment and said supervisory object devices;
storing in a model storage section via said input device said network configuration information in which a function of said network configuration is combined as a sub-model, and said device performance information;
storing in a parameter storage section by means of said input device said device performance information and said data traffic patterns;
activating a performance evaluation section by said input device to acquire information regarding said data traffic patterns from said parameter storage section;
preparing a generation schedule of packets generated by said supervisory equipment and said supervisory object devices;
analyzing performance of each of said packets correspondingly associated with said supervisory equipment or said supervisory object devices; and
calculating approximate calculation value in a case where said sub-model to be analyzed, which has been acquired from said model storage section, is a sub-model to be subjected to approximate calculation, calculating performance value in a case where said sub-model is a sub-model on which no approximate calculation is performed, and outputting to an evaluation result output device performance analytical results by combining said approximate calculation value and said performance value.

2. A method for analyzing performance of a large-scale network supervisory system according to claim 1, wherein in said step of storing in said parameter storage section, said section stores performance values and setup values, said performance values including a rate of processing performed between said supervisory equipment and said supervisory object devices, and a rate of a communication buffer and a network, and said setup values with respect to a traffic including a frequency of administration messages and data amount exchanged between said supervisory equipment and said supervisory object devices.

3. A method for analyzing performance of a large-scale network supervisory system according to claim 1, wherein said sub-model is a supervisory object device if said data traffic patterns are assumed to be performance evaluation.

4. A method for analyzing performance of a large-scale network supervisory system according to claim 1, wherein said approximate calculation is a performance-degradation calculation for bus arbitration executed in the Ethernet.

5. A method for analyzing performance of a large-scale network supervisory system according to claim 1, further comprising the steps executed in said performance evaluation section, said steps including;
performing in a queuing analytical section queuing simulation by inputting connection information on the queuing, and performance information regarding packet arrival intervals and a service rate;
outputting from a queuing analytical section a packet processing time, and a utilization factor and a queue length of each queue;
holding in an approximate calculation section a functional algorithm and a conversion table used for performing approximation on performance value including a delay time of a model, and outputting an approximate value of the performance value to be obtained for the input; and
calculating in a performance evaluation controller in accordance with information from said approximate calculation section, said model storage section, and said parameter storage section, by utilizing said approximate calculation section for portion of a model to be simulated by the approximate calculation, and by using said queuing analytical section for other portions, performance analytical results by combining analytical values from associated two kinds of modules.

6. A method for analyzing performance of a large-scale network supervisory system according to claim 5, wherein in said calculating step performed by said performance evaluation controller, said controller administers the time associated with a generation schedule of packets as a virtual time in the simulation.

7. A method for analyzing performance of a large-scale network supervisory system according to claim 5, wherein said performance evaluation controller executes a statistical processing including calculations for obtaining a mean value, a maximum value, a minimum value, and a standard deviation of the results obtained by processing the packets.

8. A method for analyzing performance of a large-scale network supervisory system according to claim 1, wherein said evaluation result output device displays the amount of money required for a system construction, by inputting said performance analytical results obtained in said performance evaluation section, and a price of a supervisory system to be evaluated that has been calculated by a device cost calculation section from said network configuration information stored in said model storage section and price information associated with each component of the network configuration.

9. A method for analyzing the performance of the large-scale network supervisory system according to claim 8, wherein said device cost calculation section holds configuration information on various network devices including various computers, hubs, and routers constituting the supervisory network, and price information regarding said components, and calculates the amount of money required for constructing the supervisory system from the number of devices and its performance, said devices being used in said sub-model held in said model storage section.

10. A method for analyzing performance of a large-scale network supervisory system according to claim 1, wherein said evaluation result output device inputs said performance analytical results obtained by said performance evaluation section, and suggestions for improvements to be outputted by a model configuration advisory section in a case where there is any portion which requires improvements, in accordance with said performance analytical results, and displays a location where a bottle neck exists and said suggestions for improvements.

11. A method for analyzing performance of a large-scale network supervisory system according to claim 10, wherein said model configuration advisory section checks whether or not a model is valid on the basis of said performance analytical results obtained by said performance evaluation section, and outputs if there is any sub-model regarded as a bottle neck, a location where the bottle neck exists and suggestions for improvements.

12. A system for analyzing performance of a large-scale network supervisory system comprising:
an input device for enabling a user to input network configuration information on a supervisory-system network, device performance information regarding a supervisory equipment and supervisory object devices, and data traffic patterns associated with said supervisory equipment and said supervisory object devices;
a model storage section for storing via said input device said network configuration information in which a function of said network configuration is combined as a sub-model, and said device performance information;
a parameter storage section for storing said device performance information, and said data traffic patterns by means of said input device; and
a performance evaluation section for acquiring information on said data traffic patterns from said parameter storage section activated by said input device, for preparing a generation schedule of packets generated by said supervisory equipment and said supervisory object devices, for analyzing performance of each packet correspondingly associated with said supervisory equipment or said supervisory object devices, and for calculating approximate calculation value in a case where said sub-model to be analyzed, which has been acquired from said model storage section, is a sub-model to be subjected to approximate calculation, calculating performance value in a case where said sub-model is a sub-model on which no approximate calculation is performed, and outputting to an evaluation result output device performance analytical results by combining said approximate calculation value and said performance value.

13. A system for analyzing performance of a large-scale network supervisory system according to claim 12, wherein said parameter storage section stores performance values and setup values, said performance values including a rate of processing performed between said supervisory equipment and said supervisory object devices, and a rate of a communication buffer and a network, and said setup values with respect to a traffic including a frequency of administration messages and data amount exchanged between said supervisory equipment and said supervisory object devices.

14. A system for analyzing performance of a large-scale network supervisory system according to claim 12, wherein said sub-model is a supervisory object device if said data traffic patterns are assumed to be performance evaluation.

15. A system for analyzing performance of a large-scale network supervisory system according to claim 12, wherein said approximate calculation is a performance degradation calculation for bus arbitration executed in the Ethernet.

16. A system for analyzing performance of a large-scale network supervisory system according to claim 12, wherein said performance evaluation section comprises a queuing analytical section for performing queuing simulation by inputting connection information on the queuing, and performance information regarding packet arrival intervals and a service rate;
a queuing analytical section for outputting a packet processing time, and a utilization factor and a queue length of each queue;
an approximate calculation section for holding a functional algorithm and a conversion table used for performing approximation on performance value including a delay time of a model, and outputting an approximate value of the performance value to be obtained for the input; and
a performance evaluation controller for calculating, in accordance with information from said approximate calculation section, said model storage section, and said parameter storage section, by utilizing said approximate calculation section for portion of a model to be simulated by the approximate calculation, and by using said queuing analytical section for other portions, performance analytical results by combining analytical values from associated two kinds of modules.

17. A system for analyzing performance of a large-scale network supervisory system according to claim 16, wherein said performance evaluation controller administers the time associated with a generation schedule of packets as a virtual time in the simulation.

18. A system for analyzing performance of a large-scale network supervisory system according to claim 16, wherein said performance evaluation controller executes a statistical processing including calculations for obtaining a mean value, a maximum value, a minimum value, and a standard deviation of the results obtained by processing the packets.

19. A system for analyzing performance of a large-scale network supervisory system according to claim 12, wherein said evaluation result output device displays the amount of money required for a system construction, by inputting said performance analytical results obtained in said performance evaluation section, and a price of a supervisory system to be evaluated that has been calculated by a device cost calculation section from said network configuration information stored in said model storage section and price information associated with each component of the network configuration.

20. A system for analyzing performance of a large-scale network supervisory system according to claim 19, wherein said device cost calculation section holds configuration information on various network devices including various computers, hubs, and routers constituting the supervisory network, and price information regarding said components, and calculates the amount of money required for constructing the supervisory system from the number of devices and its performance, said devices being used in said sub-model held in said model storage section.

21. A system for analyzing performance of a large-scale network supervisory system according to claim 12, wherein said evaluation result output device inputs said performance analytical results obtained by said performance evaluation section, and suggestions for improvements to be outputted by a model configuration advisory section in a case where there is any portion which requires improvements, in accordance with said performance analytical results, and displays a location where a bottle neck exists and said suggestions for improvements.

22. A system for analyzing performance of a large-scale network supervisory system according to claim 21, wherein said model configuration advisory section checks whether or not a model is valid on the basis of said performance analytical results obtained by said performance evaluation section, and outputs if there is any sub-model regarded as a bottle neck, a location where the bottle neck exists and suggestions for improvements.
